(19) United States
(12) Patent Application Publication
(10) Pub. No.: US 2004/0157657 A1
(43) Pub. Date: Aug. 12, 2004

(54) Moving element game

(76) Inventors: David Loewenstein, Rye Brook, NY (US); Martin Joel Wolff, New York, NY (US)

Correspondence Address: DAVID LOEWENSTEIN, 802 KING ST., RYE BROOK, NY, 10573, US

(21) Appl. No.: 10/640,084

(22) Filed: Aug. 13, 2003

Related U.S. Application Data
(63) Continuation-in-part of application No. 10/156,381, filed on May 28, 2002.

(51) Int. Cl. G06F 17/00

(52) U.S. Cl. 463/13

(57) ABSTRACT

This invention is for a poker-type card game, a method to play a game and an electronic device that displays the game. The game is played by having rows or columns of cards move across a video screen. An icon moves across the screen. When the icon hits a card, that card becomes part of the player's hand. The hand can then be compared to a paytable and the player is paid accordingly. The game can also be played with symbols instead of cards, and the icon can either be controlled by the player or it can move automatically.

This is a continuation in part of application Ser. No. 10/156,381, the entirety of which is incorporated by reference, and is based on Provisional Application 60/403,200.

This invention is a poker-type card game that incorporates moving cards to enhance the player's enjoyment, which will make him play the game longer and more frequently, and thus be lucrative for casinos. This game can be played on electronic devices such as conventional casino video games, hand-held electronic games, home computers, and over the internet. Another version of the invention uses moving symbols instead of moving cards.

### BACKGROUND

There is a popular video game called “Frogger” in which a player, using a frog icon, travels through a maze-like path. One of the obstacles the frog must traverse is a river with logs that float past the frog. The frog must leap from the shore across the logs to the other side. The timing of the player's frog leaps is crucial—if he does not time his leaps correctly, the frog will fall into the water and the player's turn is over.

In the applicant's parent application Ser. No. 10/156,38 1, he described, inter alia, a poker game that had five horizontal rows of cards moving across the screen. In that game, the player tried to line up the most valuable poker hand under a line on the screen. When the player believed he had the best hand aligned, he would select those cards and they would become his hand.

The current invention is related to that game insofar as in one embodiment it has five horizontal rows with random cards that move across the screen. However, instead of a line, as in the parent application, which the player uses to select all the cards simultaneously, the player selects one card at a time from each row by moving an icon vertically across the screen one row at a time. Each card the icon touches becomes part of his hand. In the case where the icon touches two cards simultaneously, the card that is selected is the card that has its center closest to the center of the icon. Alternatively, the card closest to the icon when it moves across a row can become the selected card.

In the symbol version of the game, the symbols the icon touches become part of a group of symbols that are compared to a paytable to determine if the player has won.

The current invention can also include an autoplay mode in which the icon moves automatically across the screen to select cards. Another embodiment is in which multiple icons are used for selecting multiple hands or groups of symbols.

### SUMMARY OF THE FIGURES

FIG. 1 shows an embodiment of the game where the cards move across the screen horizontally, and the icon moves from the top to the bottom crossing the rows of cards.

FIG. 2 shows the same embodiment with one card selected.

FIG. 3 shows this embodiment with all five cards selected.

FIG. 4 shows the embodiment where three icons start at the top of the screen and travel down.

FIG. 5 shows the embodiment where three icons are used, one at the top and two at the bottom.

### DETAILED DESCRIPTION OF THE FIGURES

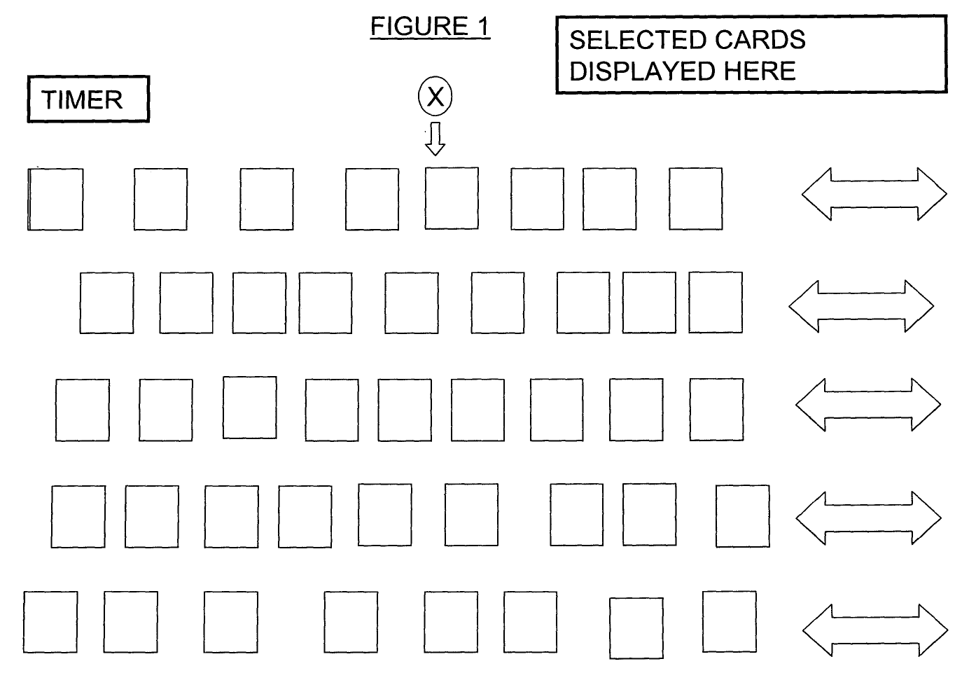

FIGS. 1 to 3 show five horizontal rows of random cards that move across the screen. The cards can be all face up or some can be face down. For example, the center row of cards could be face down and the other all face up.

The player starts at the top or bottom of the screen and is required to reach the other side to complete his hand. In a preferred embodiment, an electronic gaming device is used that has a visual display and various controls, including a control that allows the player to control the motion of the icon. The control could be a push button or it could be a voice command. In one embodiment the player would attempt to time the icon's motion so that when the icon moves to a row of cards it touches a card that believes will provide a good poker hand.

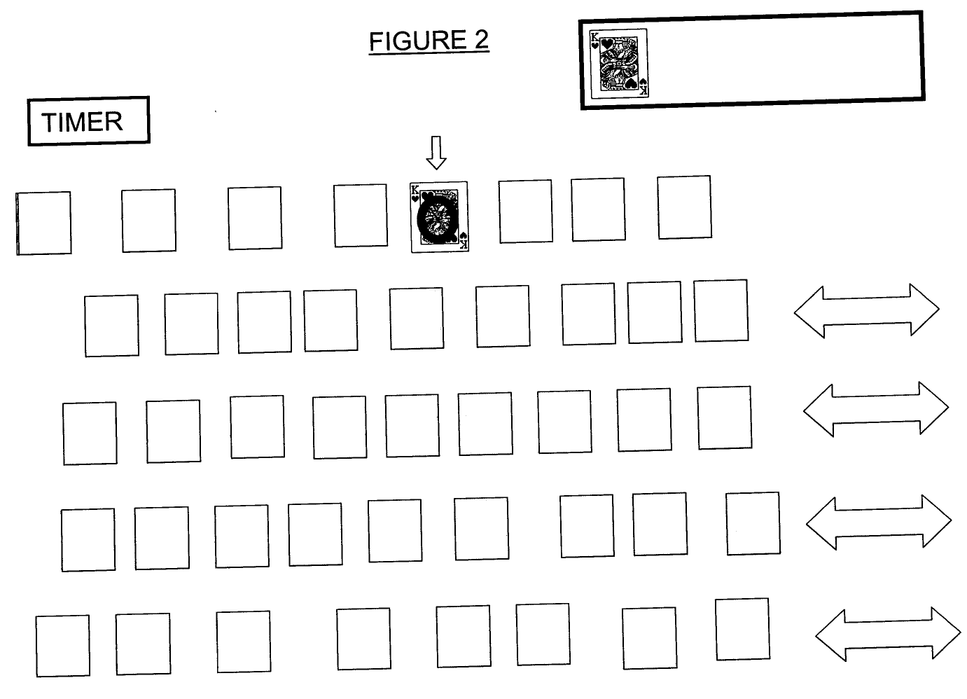

When the icon touches a card in a row, that card would be selected to be part of the player's hand, as shown in FIG. 2.

The selected cards could be displayed at the margin of the screen (see FIG. 2) or highlighted in the row after they are selected or both. FIG. 2 shows the same embodiment as FIG. 1 with one card, the king of hearts, selected from the first row and displayed separately in the upper right hand portion of the screen. In a preferred embodiment, after a card is selected in a row, the row stops moving, and the icon continues to the next row.

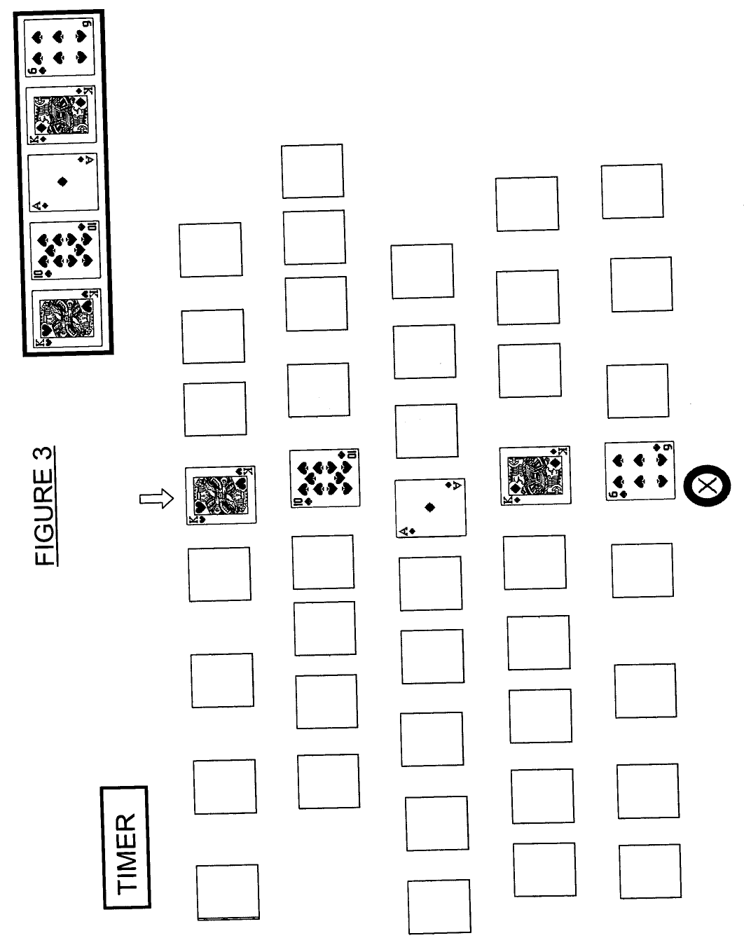

After the player finished traversing the screen, the select d cards would be displayed on the screen, as shown in FIG. 3. In a preferred embodiment, the screen would refresh and the cards would be displayed on a new screen. In one version of the game, the selected cards would be compared to a paytable, and the player would be paid accordingly. In another version of the game, the player would be given the opportunity to hold certain cards, and the non-held cards would be discarded and replaced. The final hand would then be compared to a pay table.

This disclosure should not be interpreted as limited to games that require paytables. The games could also be played with a simulated opponent so that instead of comparing the cards to a static paytable, the game could deal another hand to a “dealer.” In this embodiment, the player could enter bets as ill conventional poker, then player's hand and the “dealer's” hands would be compared and the winner determined. If the player's hand was better than the other hand, he would win the pot.

The spacing of the cards in each row need not be uniform and the motion of the cards need not be unidirectional. The directions and speed of the cards can be smooth and constant or the direction could change. In one embodiment, the direction of the cards would alternate from one row to the next.

Once cards move off the screen, there are a number of ways for more cards to appear in each row. The same cards could reappear at the beginning of the same row or they could appear in another row and cycle through some or all of the rows. The game is also not limited to a single deck of cards so that the same card can appear multiple times in the same row. Alternatively, the cards could reverse directions and move back and forth across the screen.

To make the game less predictable, and perhaps more enjoyable, bonus cards could be inserted in a row, or blank cards could be in each row. If the player's icon landed on a blank card, he would loose. Bonus cards and blank cards could be arranged next to each other so that the player would have the incentive to land on the bonus card, but if he missed, he would have a blank card and would lose.

In another version of the game, face up and face down cards could be interspersed in each row.

Obviously, the same game could be played with vertical columns of cards where the player was required to go from one side to the other horizontally.

To quicken the pace of the game, the speed at which the cards move could increase with how long the player takes to complete the trip from one side of the screen to the other. Another method would be to implement a timer that requires the player to select his cards within a fixed period of time. If the player has not made his selection within that time, the game will automatically select the cards. If a timer is used, the remaining time can be displayed on the screen as shown in FIG. 1.

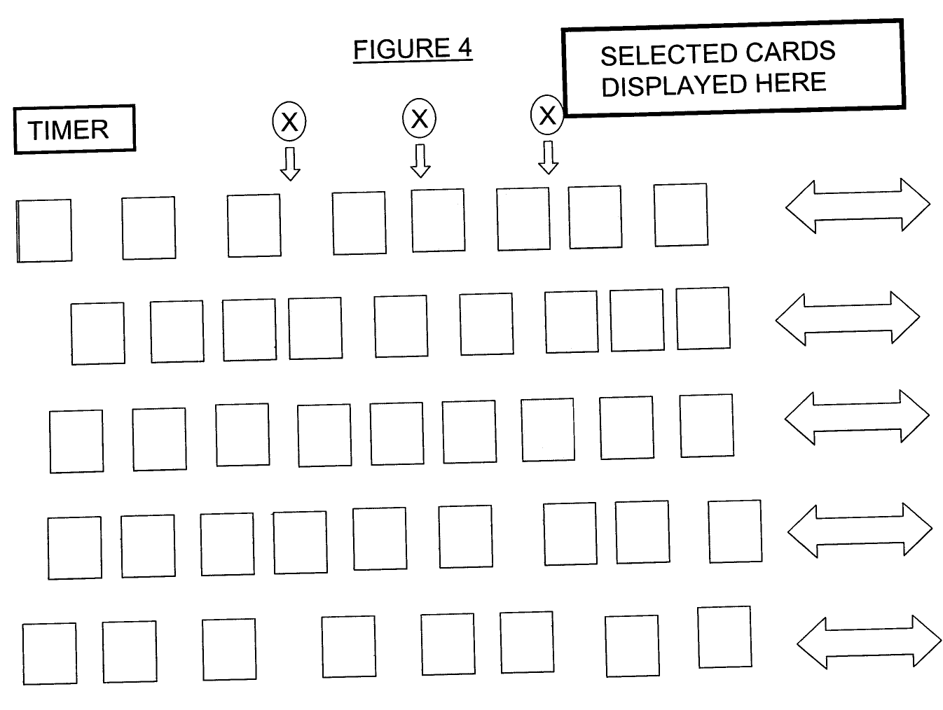

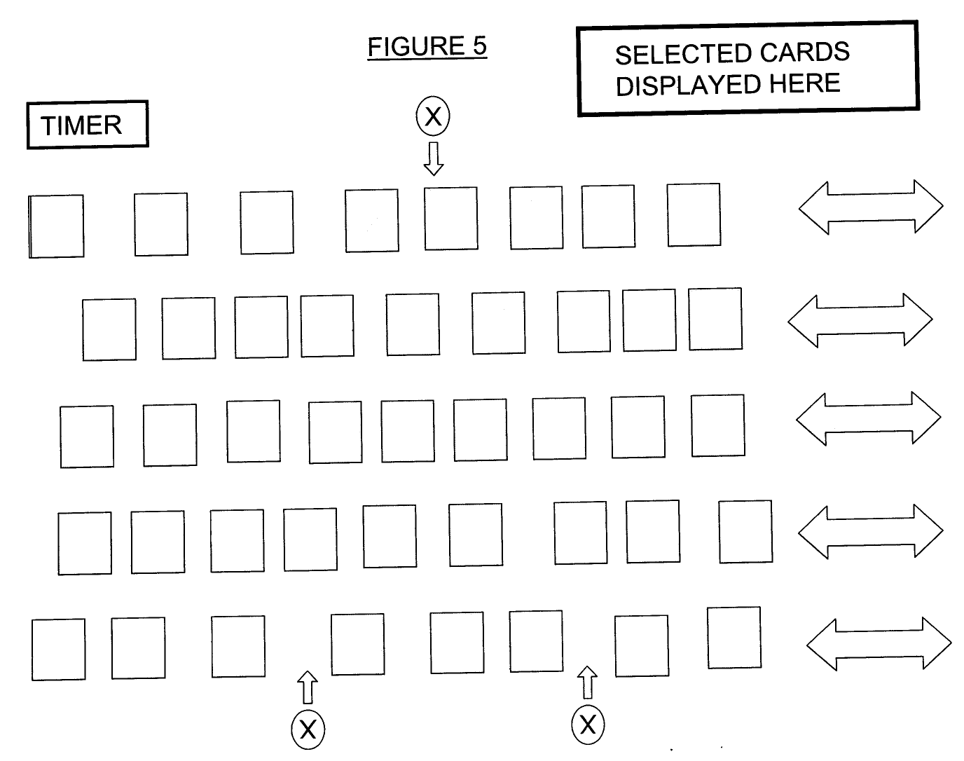

To make the game play faster or to remove any skill, the icon can be made to move automatically from row to row, thereby automatically selecting cards. Furthermore, more than one icon can be made to move across the screen, either automatically or under the player's control, so that more than one hand or group of symbols can be selected in a single game. An embodiment with three icons is shown in FIGS. 4 and 5.

In FIG. 4, three icons start at the top of the screen and move down either under the player's control or automatically.

In FIG. 5, one icon is on the top and two are on the bottom. In this embodiment the top icon moves down and the bottom icons move up. The movement can be done simultaneously. In either of the multiple icon configurations, one or more of the icons could be controlled by the player and the remaining icons could move automatically.

The symbols selected by the icon need not be limited to playing cards. Other symbols such as fruits, numbers, or similar indicia could be used to form a group. If more than one icon is used, groups of symbols are selected as the icons move across the rows. The group or groups of symbols would then be compared to a paytable.

This game can be played as a separate game or possibly as a bonus round for another game.

1. An electronic video poker game comprising one or more visual displays, each visual display shows one or more rows or columns of cards such that:
a. the cards move across the visual display;
b. a player-controlled icon travels across the visual display;
c. when the icon touches a card, that card is selected;
d. the cards that are selected form a poker hand; and
e. the poker hand is compared to a paytable:

2. The game of claim 1 where the cards are arranged as rows.

3. The game of claim 1 where the cards are arranged as columns.

4. The game of claim 1 where the cards are arranged as fewer than 5 rows or columns.

5. The game of claim 1 where the cards that are selected are displayed on the screen as they are selected.

6. The game of claim 1 where some, but not all cards are face up.

7. The game of claim 1 where there is a timer to limit the amount of time the player has to select his cards.

8. The game of claim 1 where the cards selected are displayed to the player and the player is given an opportunity to hold certain cards; cards that are not held are replaced, and the resulting hand is compared to a pay table.

9. The game of claim 1 where the icon moves automatically.

10. A method to play a poker type card game on an electronic device comprising one or more visual displays where the visual display shows the following:
a. one or more rows or columns of cards;
b. the cards move across the visual display;
c. a player-controlled icon that travels across the visual display;
d. when the icon touches a card on the visual display, that card is selected;
e. the cards that are selected form a poker hand; and
f. the poker hand is compared to a paytable.

11. The method of claim 10 where the cards are arranged as rows.

12. The method of claim 10 where the cards are arranged as columns.

13. The method of claim 10 where the cards that are selected are displayed on the screen as they are selected.

14. The method of claim 10 where some, but not all cards are face up.

15. The method of claim 10 where there is a timer to limit the amount of time the player has to select his cards.

16. The game of claim 10 where the cards selected are presented to the player and the player is given an opportunity to hold certain cards; cards that are not held are replaced, and the resulting hand is compared to a pay table.

17. An electronic device comprising one or more visual displays, at least one of the visual displays shows the following:
a. one or more rows or columns of cards;
b. cards that move across the visual display;
c. a player-controlled icon that travels across the visual display; and
d. when the icon touches a card, that card is selected;
e. the cards that are selected form a poker hand;
f the poker hand is compared to a paytable; and
g. the poker hand is compared to a paytable.

18. The electronic device of claim 17 where the cards are arranged as rows.

19. The electronic device of claim 17 where the cards are arranged as columns.

20. The electronic device of claim 17 where the cards that are selected are displayed on the screen, as they are selected.

21. The electronic device of claim 17 where some, but not all cards are face up.

22. The electronic device of claim 17 where there is a timer to limit the amount of time the player has to select his cards, and the amount of time remaining is displayed on the screen.

23. A method to play a game on an electronic device comprising one or more visual displays and where at least one of the visual displays shows the following:
a. one or more rows or columns of symbols,
b. the symbols moving across the visual display;
c. an icon that travels across the visual display;
d. when tie icon touches a symbol on the visual display, that symbol is selected;
e. a group of symbols is created from each selected symbol;
f. the group of symbols are compared to a paytable; and
g. the player is paid according to the paytable.
